(19) United States
(12) Patent Application Publication
(10) Pub. No.: US 2010/0269094 A1
(43) Pub. Date: Oct. 21, 2010

(54) TECHNIQUE FOR AUTOMATICALLY GENERATING SOFTWARE IN A SOFTWARE DEVELOPMENT ENVIRONMENT

(76) Inventors: Roman Levenshteyn, Aachen (DE); Per Pettersson, Montreal (CA)

Correspondence Address: ERICSSON INC., 6300 LEGACY DRIVE, M/S EVR 1-C-11, PLANO, TX, 75024, US

(21) Appl. No.: 12/742,844

(22) PCT Filed: Nov. 13, 2007
(86) PCT No.: PCT/EP2007/009812

§ 371 Date: May 13, 2010

(51) Int. Cl. G06F 9/44

(52) U.S. Cl. 717/109

(57) ABSTRACT

Techniques for automatically generating software in a software development environment. An exemplary method comprises the steps of interpreting feature description data related to a program library; interpreting the feature description data as a machine-readable description of a feature to be provided by the software development environment; allocating, based on the interpreted feature description data, one or more user-operable control elements in the software development environment; and, providing access, via the control element, to one or more operations related to the feature description data.

### TECHNICAL FIELD

The invention relates to the field of software development technologies, and more particularly to the automatized generation of software in software development environments.

### BACKGROUND

Computing devices can today be found in virtually any technical field. Microprocessors, microcontrollers, embedded devices, signal processors etc. are used for controlling purposes, sensing purposes, performing calculations and other tasks which formerly have been performed mechanically, electrically, or manually.

For reasons of deployment flexibility, most computing devices are programmable, at least to some degree. Therefore, the processing hardware in an industrial production machine, robot, etc. as well as the microchip in a handheld computer or mobile phone needs to be programmed by software or firmware (or a combination thereof) in order to enable a proper operation of the controlled device, provide a user interface to an operator or user, detect error conditions, etc. As a concrete example, most of the features of a today's mobile phone are typically implemented in software on a microprocessor, e.g. in the form of applications written in Java or its derivatives.

The increasing importance of programmable devices is therefore accompanied by an increasing importance of software development for such devices. In fact, the software development area is an industry with a constantly diversifying manifold of technologies. On the one hand, software development has to cope with the very different requirements of, for example, real-time systems (for airplanes as well as mobile phones) and database systems (for storing large amounts of data, e.g. for the financial area). On the other hand, techniques aiming to support the software developer in writing code become more and more elaborated in order to allow the construction of ever more complex software systems within a reasonable time and with using a reasonable amount of human resources.

From a developer's point of view, a typical software system may comprise a code (the terms ‘code’, ‘program’, ‘software’ are used synonymously herein) representing the required functionality in one or more programming languages suited best for the tasks to be solved. However, not each and every functionality is explicitly programmed in the code. Many tasks are repetitive and therefore such tasks are programmed once and then provided in the form of program libraries. Basically, a program library is a packaged suite of one or more files including coded functions. The library may be available locally or remotely. In the latter case they may be accessed, e.g., via the Internet during execution. For instance, web services and AJAX (Asynchronous JAvaScript and XML) services make use of remote libraries. In order to perform a specific task, a software system may integrate an appropriate program library and may then simply put a call to a function which is implemented by the library. The developer of the software system does not need to know in which way the function is implemented in the library. Instead, he or she only needs to know the Application Programming Interface (API), which specifies for a functionality the name of the corresponding function or functions as well as names and types of parameters required when calling this function. The API has to be provided by the developer of the library.

Often a software library is a part of a Software Development Kit (SDK), which further includes information regarding the API, example code, general documentation, etc. As an example, a basic Java Development Kit (JDK) may provide basic functions in order to support the development of Java-based software, and may in this respect comprise various class libraries, developer tools, example code and API-documentation for Java developers. Another SDK may implement more specific functionalities, e.g. relating to particular applications for mobile phones. For developing a software system in Java for a mobile phone, a developer may then want to integrate both SDKs. As program libraries potentially save considerable development resources, the integration of program libraries is an important aspect of software development.

A software development environment may simply comprise an editor and a compiler running on a general purpose computer which provides enough storage place for the resulting program. In order to support complex software development projects, more elaborated tools such as Integrated Development Environments (IDEs) are available. An IDE typically provides a graphical user interface (GUI) and aims at supporting its user (i.e., developer) in performing typical tasks such as writing, editing, compiling, building and executing code as well as debugging and testing of the software system under development. An enhanced software development environment such as an IDE also offers the possibility of automatically generating some code fragments in response to the user clicking on a corresponding button of the GUI or performing a similar action. For example, in case the user wants to create a new class, clicking on a button “Create_New_Class” may trigger the opening of a new window within the GUI of the IDE presenting some template class definition, which may then be edited by the user. Some of today's most powerful IDEs aim to offer the developer a common environment for such different activities as developing software in Java, generating some code from an analysis study performed in a meta language such as the Unified Modelling Language (UML), and developing web applications in HTML. The tendency is that IDEs become general development platforms.

It is clear that even a sophisticated environment such as an IDE cannot include all the software libraries as built-in features which now, or in future projects, may potentially be required. Instead, IDEs are extendible by so called plug-ins, which are separate components that can be integrated into the IDE on demand of the user and which then enable the IDE to provide some add-on functionality. For example, an IDE providing an environment for developing Java applications may be enhanced in order to allow developing software in C++, PHP and/or PERL by integrating corresponding plug-ins. Other plug-ins may allow to access databases from within the IDE or to generate UML diagrams and to generate Java code therefrom. A modern IDE thus comprises as an essential component a core which provides mechanisms for integrating plug-ins and manages the interaction of the possibly many different plug-ins. Such plug-in mechanisms are for instance specified by the OSGI (“Open Services Gateway Initiative”), see www.osgi.org.

As an example for demonstrating the power of the plug-in approach, domain-specific software development can be mentioned, which aims at developing a software system in a specific domain of interest. Such a domain may be, e.g., software development in the area of telecommunications or for workflow-based office systems. Domain-Specific programming Languages (DSLs) may be available for a domain. Plug-Ins may be provided in order to specifically enhance IDE capabilities; for example, the GUI may be extended in order to allow the user to access domain-specific functionality. The IDE extension resulting from integrating a plug-in may also comprise a wizard for automating specific tasks. As an example, an XML (eXtensible Markup Language) web services support wizard may be able to generate code in a given programming language such as Java based on a formal description of the service to implemented given in, e.g., WSDL (Web Services Description Language). Other wizards enable a GUI-based design of a user interface for an application, which may only afterwards be transformed into a program code implementing this interface. Still other IDE extensions enable packaging a given software into formats as required for later deployment, e.g. as an executable file, plug-in, etc.

To achieve integration of a plug-in into an IDE, the API of the software libraries of the plug-in must be made known to the IDE. Further, some functionality must be provided by the IDE in order to make the functions provided by the plug-in available to the IDE user. Therefore plug-ins need one or more components to achieve the integration into any specific IDE. This requires knowledge of the internal mechanisms of the IDE. Developing IDE plug-ins thus is a difficult task for non-professional IDE developers as, for example, the developers of a 3^{rd} party library. This is the reason why IDE plug-ins are often only delivered by the IDE vendor.

As IDE plug-ins are IDE specific, in principle for each program library multiple IDE plug-ins have to be developed, one plug-in for each IDE into which one may wish to integrate the library support. However, the resources for providing many IDE plug-ins are typically not available for other than the most important and basic program libraries. For libraries relating to, e.g., domain-specific software development, only plug-ins for one or two IDEs may in general be available.

This leads to the situation that a program library implementing some highly relevant functionality may be difficult and inconvenient to use in a particular IDE due to the lack of library-specific support, i.e. because there exist no corresponding IDE plug-in for this library. Thus the developer has either to create its own library, although this functionality has already been implemented, which is a waste of resources. Or the developer has to use a different IDE, for which a corresponding plug-in exists. This is also a waste of resources, as the developer may realistically be familiar with only one or two of the complex environments for professional software development, and thus it takes time for him to become familiar with the further IDE. The situation becomes worse in case multiple libraries are required for a project and the plug-ins available are adapted to multiple different IDEs.

### SUMMARY

There is a demand for a technique for simplifying the integration of a program library into a software development environment.

This demand is satisfied by a method for automatically generating software in a software development environment. The method comprises the steps of receiving feature description data related to a program library; interpreting the feature description data as a machine-readable description of a feature to be provided by the software development environment; allocating, based on the interpreted feature description data, one or more user-operable control elements in the software development environment; and providing access, via the control element, to one or more operations related to the feature indicated by the feature description data.

The software development environment may be any environment providing a functionality for eventually automatically generating software. This may even be an editor which is adapted to trigger a compiler operation on data held by the editor. Typically, a software development environment comprises a user interface, for example a GUI, and provides extensive functionality including development operations related to software development, i.e. operations related to writing, editing, compiling code, etc., but also operations related to the management of the development environment itself. The managing operations may comprise operations for managing implemented plug-ins, controlling dependencies of plug-ins from each other and executing implemented modules in the required sequence. For example, the managing operations may be OSGI based. As an example, an operation which is related to enabling the software development environment to provide a particular editor or compiler may be a management operation, while an operation related to the use of this particular editor or compiler is a development operation.

A feature of the software development environment may comprise one or more operations. The one or more operations related to the feature indicated by the feature description data may be management operations and/or development operations. At least one of these operations may be based upon a functionality implemented by the program library. This functionality may be related to development operations or management operations. As a concrete example, in case an operation is a managing operation, this operation may be related to a particular compiler or editor, wherein the editor or compiler is invoked by the program library. Another operation may be related to a function implemented in the program library, wherein the function may be implemented in an software application to be developed by the development environment. As a concrete example, the operation may comprise to automatically generate, in response to an activation of the control element, a software fragment including a call of the function.

The functionality implemented by the feature description data may be represented by a software artifact such as a software library, SDK or plug-in, but may also be given in the form of a build script, a GUI description, or in textual form. The functionality may even only be represented by the feature description data. In this case one or more operations may entirely be constructed, based on the prescription given in the feature description data, from IDE specific functionality, e.g. IDE built-in operations. In case the operation is a domain-specific operation, it may be implemented in a DSL. In this case the IDE would require a domain-specific interpreter, compiler or similar translation tool in order to perform the operation.

The feature description data may describe a user interface for an operation. As one example, the feature description data may specify some portion of a menu or one or more buttons to be provided on a GUI of the IDE in order to allow a user (developer) to use a functionality, e.g. to access it or to include a function call in a code to be developed. Such a description may additionally or alternatively comprise required user inputs including types, names and “look & feel” of input values. The description may also include a description of actions to be performed in response to a user input.

The feature may be related to an automatic generation, in response to an activation of the one or more control elements, of at least one software fragment for an application to be developed by the software development environment. For example, upon interaction of the user with menus, dialogs, buttons, etc., a call to a function implemented by the library may be included in a software under development in the development environment.

The feature may be a domain-specific feature. For example, according to the feature the software development environment may be configured to offer access to domain-specific functionality, i.e. operations.

The feature description data may also describe an interaction of operations with required functionality of the IDE. Such requirements may relate to, e.g., a run-time environment, compilation options, etc.

In some realizations of the method, the feature description data may be provided for being interpreted in different software development environments, for example by providing the feature description data in a format understood by various development environments. For instance, the feature description data may be provided in a general programming language such as Java, C++ and/or HTML.

The step of interpreting the feature description data may comprise mapping at least a portion of the feature description data provided based on the general programming language to an environment specific format for at least one of allocating the control element and providing access via the control element to operation(s), which may, e.g., be implemented by the features contained in the program library. The environment specific format may be one used for implementing the software development environment. For example, HTML based feature description data may be mapped to such an IDE internal format. This format may make use of a predefined syntax and may, e.g., be text-based or binary-based. The mapped description data describing the operations, e.g. according to an IDE extension, may be used to perform these operations in later steps.

The feature description data may additionally or alternatively be provided based on a feature description language specifically designed for this purpose. This language may or may not be IDE-independent. A mapping to an environment specific format may also be performed in a similar way as has been described in the preceding paragraph.

The feature description data may also comprise multiple portions related to different aspects of operation(s) the feature is based upon, e.g., the feature description data may be related to at least one of user inputs, user interface functionality, wizard functionality, requirements on the IDE and requirements on a run-time environment. Correspondingly, the feature description data may also be specified in multiple different feature description languages. As an example, a part of the feature description data related to a user interface may be specified in HTML, XML, XUL or WSDL, while another part related to operations to be performed by the IDE in response to some user input might be specified in Java, JavaScript, VBScript, etc. It is noted that formats such as HTML or XUL allow for a concise machine-readable description of user interfaces (for example, XUL is used to define the GUI of the well-known Firefox Web browser).

The feature description data may also be provided in different languages and may in this way be adapted to different IDEs. For example, one and the same description may be provided two times, one time in HTML and one time in WSDL. In one variant of the method, different portions of the feature description data may be specified in different languages.

The user-operable control elements may comprise user interface elements, such as menus, input format prescriptions, dialog windows or boxes, buttons, etc. for enabling a user to perform the operation. Additionally, the step of allocating control elements may comprise allocating interaction components, such as variables, parameters, storage place or specific interaction objects for providing an interaction of the operation with other management and/or development operations of the software development environment. The term ‘allocation’ is intended to cover any activation or provision of a logical hardware or software processing resource, including, e.g., the instantiation of objects as known from object-oriented programming environments.

The step of providing access to the operation(s) may comprise connecting the control element(s) with one or more actions to be performed by the software development environment upon activation of the control element by the user. For example, the action may comprise to provide a software fragment (e.g., a function call), process the fragment according to a user dialog, and input the processed fragment into a code under development within the environment. As another example, the action may comprise starting an editor, compiler, etc.

The method may comprise the initial steps of accepting input data; and parsing the accepted input data to detect the feature description data. The input data may only comprise the feature description data, e.g. in case the data are distributed separately from the related program library. In another variant, the input data comprise a program library, extension or SDK implementing operations related to the feature and the feature description data. It is to be noted that, while the term ‘plug-in’ is used herein to denote components adapted for integration into a specific (particular) software development environment, the term ‘extension’ is used in a wider sense to comprise, besides plug-ins, also components adapted for integration into more than just one software development environment. For example, an extension may comprise a program library and feature description data as defined herein.

According to one realization, the feature description data are included within the code of the program library. For example, the data may be provided in one or more particular feature description files. In another alternative, the feature description data are embedded within at least one of a source code or a binary code of the program library. For example, the feature description data may be embedded into the code in the form of at least one of comments or annotations, e.g. annotations as known in Java.

In some variants of the method, the feature description data may comprise a fragment of executable code for being executed by the software development environment. For example, the code fragment may be executed in response to an activation of a control element in order to perform an operation indicated by the feature description data.

The above-mentioned demand is further satisfied by a computer program product which comprises program code portions for performing the steps of any one of the method aspects described herein when the computer program product is executed on one or more computing devices, for example a general purpose computer, a workstation specifically adapted to software development, or in a distributed hardware environment. The computer program product may be stored on a computer readable recording medium, such as a permanent or re-writeable memory within or associated with a computing device or a removable CD-ROM, DVD or USB stick. Additionally or alternatively, the computer program product may be provided for download to a computing device, for example via a data network such as the Internet or a communication line such as a telephone line or wireless link.

The above-mentioned demand is further satisfied by a tool for a software development environment for automatically generating software. The tool comprises a first component adapted to receive feature description data related to a program library; a second component adapted to interpret the feature description data as a machine-readable description of a feature to be provided by the software development environment; a third component adapted to allocate, based on the interpreted feature description data, one or more user-operable control elements in the software development environment; and a fourth component adapted to provide access, via the control element, to one or more operations related to the feature indicated by the feature description data.

Still further, the above-mentioned demand is satisfied by a tool for providing a program library for incorporation into one or more software development environments. The tool comprises a component adapted to provide feature description data representing a machine-readable description of a feature to be provided by the software development environment, the feature being related to a functionality implemented by the program library. The tool may be a stand-alone tool or may be a plug-in or built-in component of the IDE. One realization of the tool may comprise a further component adapted to include the feature description data within an extension package (i.e. a program library package including the program library and additional data such as instruction files, example files, etc.). In one variant of this realization, the further component is adapted to include the interface description data within the code of the program library.

The above-mentioned demand is further satisfied by a program library for incorporation into one or more software development environments. The library includes feature description data representing a machine-readable description of a feature to be provided by the software development environment, the feature being related to a functionality implemented by the program library.

### BRIEF DESCRIPTION OF THE DRAWINGS

In the following, the invention will further be described with reference to exemplary embodiments illustrated in the figures, in which:

FIG. 1 is a flow diagram illustrating a first embodiment of a method for incorporating a feature into a software development environment;

FIG. 2 is a combination of flow diagrams for a process of generating an extension, integrating the extension into an IDE and using the functionality of the extension within the IDE;

FIG. 3 is a flow diagram illustrating a second embodiment of a method for incorporating a feature into a software development environment;

FIG. 4 is a block diagram schematically illustrating components of an embodiment of an IDE;

FIG. 5 is a functional block diagram schematically illustrating components of an embodiment of a tool for incorporating a feature into the IDE of FIG. 4;

FIG. 6 is a schematic illustration of an embodiment of a GUI of the IDE of FIG. 4 in a first operational state;

FIG. 7 is a schematic illustration of components of an embodiment of an extension,

FIG. 8 is a functional block diagram schematically illustrating components of an embodiment of a tool for generating an extension;

FIG. 9 is a block diagram schematically illustrating components of the IDE embodiment of FIG. 4 after integration of the extension of FIG. 7;

FIG. 10 is a schematic illustration of the GUI embodiment of FIG. 6 in a second operational state after integration of the library of FIG. 7;

FIG. 11 is a schematic illustration of the GUI embodiment of FIG. 6 in a third operational state.

### DETAILED DESCRIPTION

In the following description, for purposes of explanation and not limitation, specific details are set forth, such as specific software development environments including particular IDEs, programming languages, etc., in order to provide a thorough understanding of the current invention. It will be apparent to one skilled in the art that the current invention may be practised in other embodiments that depart from these specific details. For example, the skilled artisan will appreciate that the current invention may be practised with IDEs comprising GUIs different from those discussed below or even with software development environments not providing any GUI. The invention may be practised with any software development environment which provides a framework for automatically generating software for an application to be developed. The term ‘software’ is intended to include any sequence of commands, which is directly executable (such as an executable code or binary code) or automatically translatable into a directly executable code (such as a program code written in a programming language, assembler code or a code written in a specific syntax for, e.g., microcontrollers or signal processors or intended as a firmware for a special purpose processor) by an interpreter, compiler or similar translation tool.

Those skilled in the art will further appreciate that functionality explained herein below may be implemented using individual hardware circuitry, using software functioning in conjunction with a programmed microprocessor or a general purpose computer, using an application specific integrated circuit (ASIC) and/or using one or more digital signal processors (DSPs). It will also be appreciated that when the current invention is described as a method, it may also be embodied in a computer processor and a memory coupled to a processor, wherein the memory is encoded with one or more programs that perform the methods disclosed herein when executed by the processor.

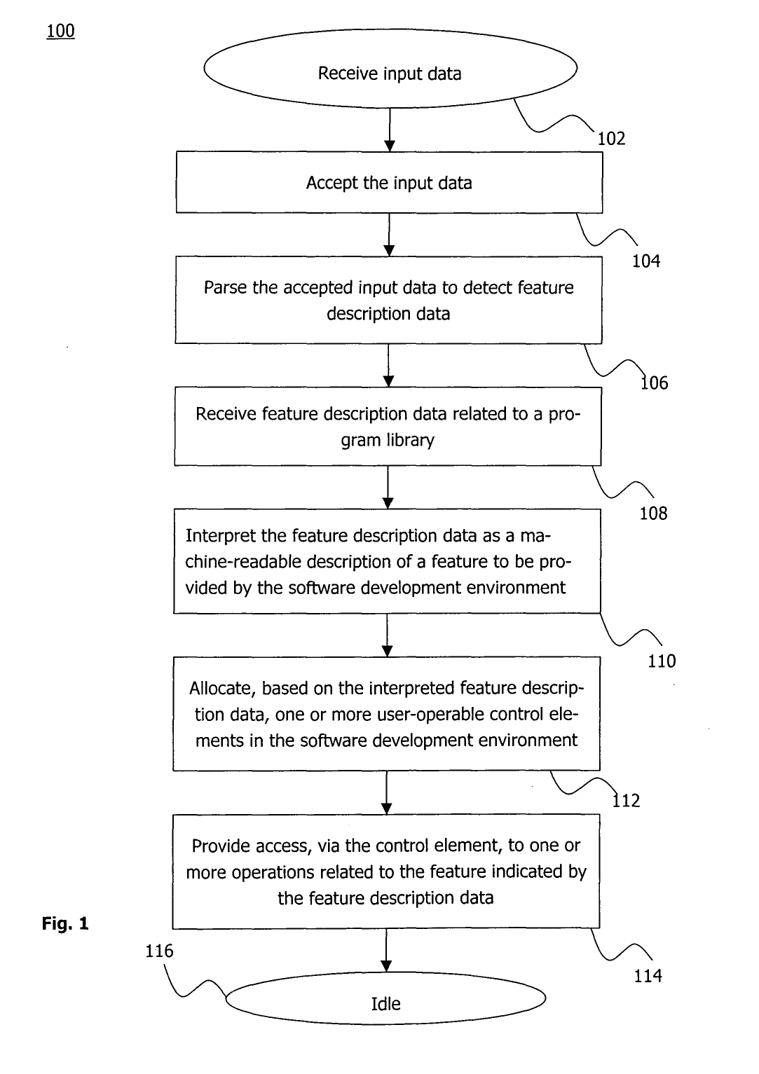

FIG. 1 is a flow diagram illustrating an embodiment of a method 100 for automatically generating software in a software development environment. The method may be performed by a respective component built into an IDE or provided as an add-on or stand-alone tool thereto.

The method 100 starts in step 102 with the reception of input data. For example, the input data may comprise an SDK or a program library. In step 104, the input data is accepted. For example, the tool may have recognised that the input data has an acceptable input format. In step 106, the accepted input data is parsed in order to detect feature description data. The respective tool or component may for example scan the input data to find a dedicated file containing feature description data or may scan the entire input data in order to detect all possible occurrences of feature description data being integrated within a code or provided as an extra data entity.

In step 108, the detected feature description data is received by a tool for interpreting it. In step 110, the feature description data is interpreted as a machine-readable description of a feature to be provided by the software development environment. The feature may include, e.g., one or more of editing, compiling, building, and testing functionalities. In step 110, one or more user-operable control elements are allocated in the software development environment, based on the interpreted feature description data. For example, a menu, buttons and/or dialogs may be provided on a GUI of an IDE.

In step 114, access is provided, via the control element, to one or more operations related to the feature indicated by the feature description data implemented by the program library. For example, an action may be connected with the control element such that upon activation of the control element the action will be performed. The action may comprise an automatic generation of code in an application to be developed and/or the start of an editor, compiler, etc., or a complex processing such as formatting all classes in a development project in a particular way or performing an action on all function calls in the code with a name matching a certain pattern.

After having incorporated the operation (or multiple operations) in this way into the software development environment, the tool or component returns control in step 116.

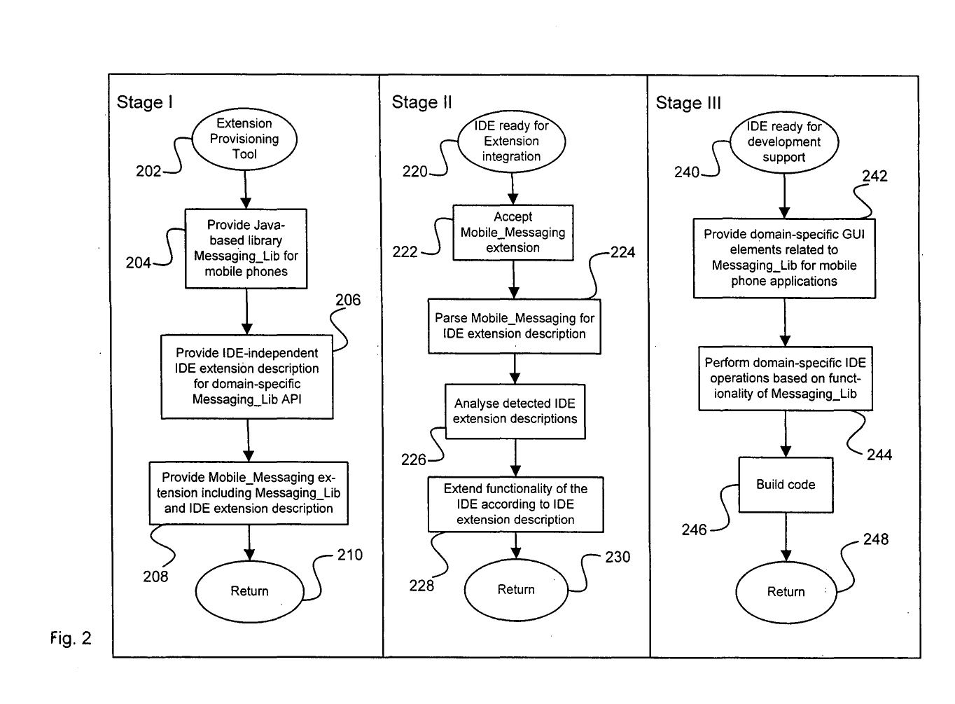

FIG. 2 provides a high-level overview of a process 200 which comprises in a stage I a provisioning of an extension for one or more IDEs, in stage II the integration of the extension into an IDE, and in stage III the use of the functionality of the extension within the IDE.

As a general example, a program library or other software artefact may comprise a function with a complex API to be included in a software application to be developed; e.g. the function call may include a set of many parameters with complicated types. Writing manually the code for invoking such a function is time-consuming and error-prone. Therefore, the provider of the library may consider adding feature description data in order to offer a user of the library the possibility to automatically generate the required code, i.e. function call, based on an extended user interface within the framework of a software development environment (stage I). The function may be of any kind, for example related to input/output of data, managing, generating and/or calculation of data, sensing data, etc.

The feature description data may be as detailed as considered necessary in its description of the user interface part. For example, the data might describe in detail a dialog for configuring the invocation of a function, including input fields for entering the values for each of the parameters expected according to the API. In this way, the parameters may be entered in a form easier to recognize by the user of the function in a time-efficient way, e.g. by also offering default values. The extended user interface may receive the parameters entered by the user of the software development environment, analyse it, and transforms it from the user-friendly form into the form required by the source code. Eventually, a piece of source code is generated for implementing the required function invocation (stage III).

Referring back to FIG. 2, it is exemplarily assumed that the extension comprises a program library implementing a set of functions related to sending messages from a mobile phone.

In stage I, a library developer invokes in step 202 an extension or SDK provisioning tool (for brevity, the terms extension and SDK may sometimes be used interchangeably herein). This tool, which may itself be a software development environment such as an IDE, is used by the developer in step 204 to provide a library “Messaging_Lib”, which may be a Java-based library containing various functions implementing functionality for sending messages such as SMS (Short Message Service) messages, MMS (Multimedia Message Service) messages or Email messages from a mobile phone over a mobile network towards a recipient.

In step 206, the provisioning tool provides an IDE extension description for the API of Messaging_Lib, more precisely the APIs of the functions included within this library. The IDE extension description is a particular embodiment of the feature description data as discussed herein. For example, the IDE extension description may be included into the Java library Messaging_Lib in the form of Java annotations in the program code. The provisioning tool may be adapted to automatically provide the IDE extension description or may be adapted to enable the library developer to enter the IDE extension description. The tool may also provide for both possibilities.

In step 208, the provisioning tool generates an extension “Mobile_Messaging” which includes the library Messaging_Lib and the IDE extension description generated in step 206. While it has been described with reference to step 206 that the IDE extension description is included into the library code, in other embodiments a separate IDE extension may be provided in an SDK or extension, for example as one or more separate text files, HTML files, etc. The provisioning tool 202 finishes operation and returns control in step 210.

Stage II is an embodiment of the method 100 of FIG. 1. In stage II, the Mobile_Messaging extension generated in stage I will be integrated within an IDE. The Mobile_Messaging extension may be provided to the IDE via the Internet or from a data carrier such as a CD-ROM or DVD.

In step 220, the IDE is ready for integration of an extension. In step 222, the IDE accepts the Mobile_Messaging extension, for example because it is in a valid format and the library Messaging_Lib is determined to be written in Java, which is accepted because the IDE supports development processes using Java.

In step 224, the integration component of the IDE parses the accepted Mobile_Messaging extension in order to detect potentially included feature description data. For example, the component may scan the extension for the occurrence of specific files or of feature description data embedded within a library code. In case of the Java library Messaging_Lib, the integration component may scan in particular for the occurrence of an IDE extension description in the form of Java annotations. A detected IDE extension description may for example be copied into an internal storage of the IDE.

In step 226, the IDE analyses the detected IDE extension descriptions. Based on this analysis, which may comprise an interpretation of the IDE extension description such as described with reference to step 110 in FIG. 1, in step 228 the functionality of the IDE is extended, i.e. support for the library Message_Lib is implemented according to the analyzed IDE extension description. This is achieved, e.g., by allocating user-operable control elements such as new user interface elements and by connecting actions to be performed upon activation of the control elements by a user of the IDE, i.e. steps similar to steps 112 and 114 in FIG. 1. The new functionalities are made available to the user, for example by presenting graphical representations of user input elements in the GUI of the IDE. In step 230, the integration component returns control to a main program of the IDE.

In stage III, the library Messaging_Lib integrated into the IDE in stage II is used by an application developer. In step 240 the IDE is ready to support a development process which supports an application developer in developing code for a software system by, e.g., writing, editing, compiling, building and/or testing the code. The support may comprise providing an editor, compiler, etc. to the developer and/or any other of the functionalities typically provided by an IDE. Based on the specific elements presented in the IDE GUI as a result of integration of the Mobile_Messaging extension in stage II, the IDE may be adapted in a domain-specific way, i.e. the IDE offers the user a particular support related to functionality provided by the library, i.e. support for implementing mobile messaging functionality into an application software for mobile phones.

In step 242, the IDE provides domain-specific GUI elements related to a use of functionality of the library Messaging_Lib. In step 244, in response to user actions, domain-specific operations are performed by, e.g., implementing function calls of the library Messaging_Lib or otherwise making use of functionality implemented by Messaging_Lib. For example, code fragments may be generated related to a Java messaging application for mobile phones. In order to implement a call to a function included in Messaging_Lib, the respective APIs are used as described in the IDE extension description. In step 246, a code is built as a result of operations performed in step 244. The code may be included into a software system comprising a set of Java applications for mobile phones. In step 248, the IDE development mode returns control to a main program, e.g. a higher-level GUI of the IDE.

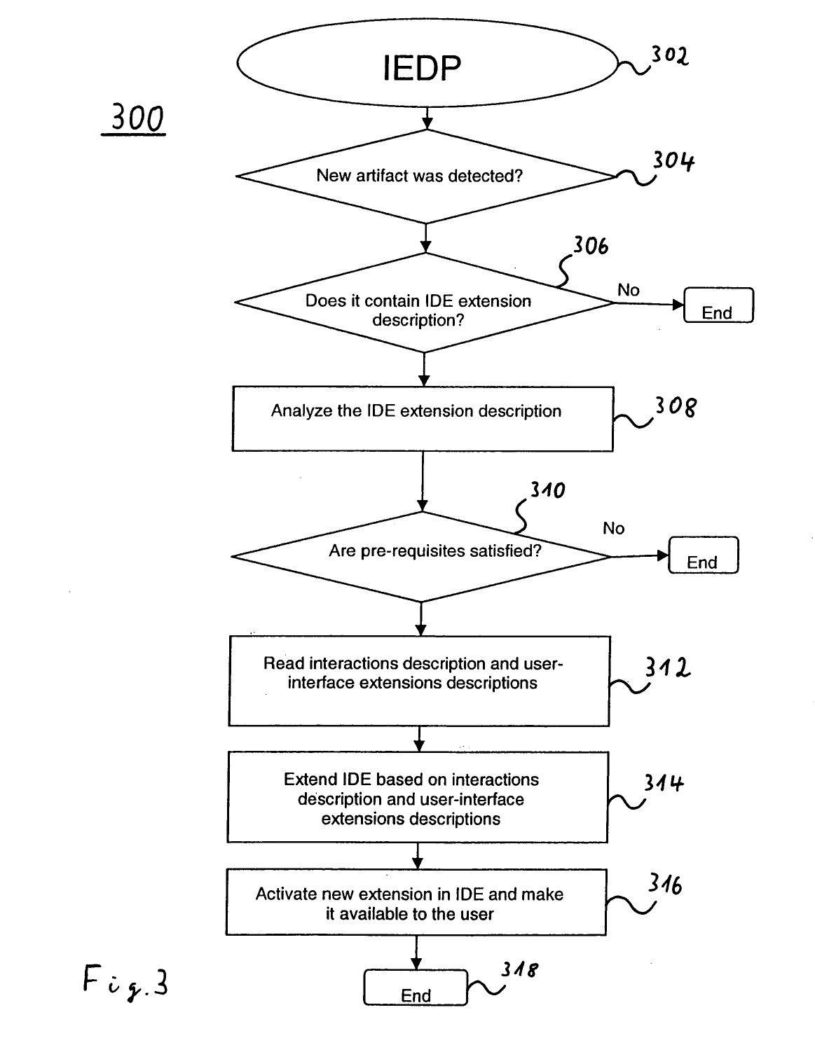

FIG. 3 is another exemplary embodiment of a method 300 for automatically generating software in a software development environment similar to method 100 of FIG. 1 or stage II of the process illustrated in FIG. 2. For method 300 it is assumed that an IDE Extension Description Processing module (IEDP) is provided which might be a built-in part of an IDE or a stand-alone application.

In step 302, the IEDP is activated. In step 304, the IEDP detects a software artifact that may contain an IDE extension description, such as a program library, an extension, an SDK, a build script, a GUI description, etc. In step 306, the detected artifact is parsed whether it contains IDE extension descriptions, for example contained within a code or in an extra, specific structure such as a specific extension description file. In case no IDE extension description is found, the procedure stops. Otherwise, the IEDP goes on in step 308 with analysing (e.g., interpreting) the detected IDE extension description(s). For each detected extension description, the IEDP reads in the description, analyses it and checks if pre-requisites required by this extension are satisfied (step 310). For example, the availability of a specific functionality in the IDE, requirements for a run-time platform, support of specific standards by the IDE may be prescribed in the IDE extension description. As a concrete example, the availability of other program libraries and a specific compiler may be required. If mandatory pre-requisites are not satisfied, the extension cannot be used by the IDE. In this case, the IEDP stops integrating at least that portion of the detected artefact related to the currently analyzed IDE extension description.

In case at least the mandatory pre-requisites are satisfied, the IEDP reads in step 312 those portions of the detected extension description related to interactions with a user of the IDE, e.g., required user inputs, format and type of user input, etc. Further, user interface extension descriptions are read, e.g., elements of an extended GUI. Further, the IDE extension description may contain descriptions of operations to be performed by the IDE as a result of a user interaction with the extended user interface.

After having interpreted the read data, in step 314, the IDE is extended based on the analysed interaction description and user interface extension description. For example, in this step a mapping of the IDE extension description to an IDE specific syntax for providing user-operable control elements within the IDE may be performed, e.g. new user interface elements may be added to the IDE GUI such as new menus, dialogues, panels, etc. As an example, a generic description contained in an IDE extension description may comprise an indication <selectFileDialog> as a request for the IDE to include a further dialogue for selecting files on its GUI. While a class with the name “selectFileDialog” may exist in every SDK/API, the resultant GUI element will look different in, e.g., an Eclipse IDE and a NetBeans IDE using each their specific SDKs.

In step 316, the IDE extensions are activated and made available to the user. The steps 312 and 314 may be a variant of the steps 112 and 114 in FIG. 1. The IEDP returns control to a main program of the IDE in step 318.

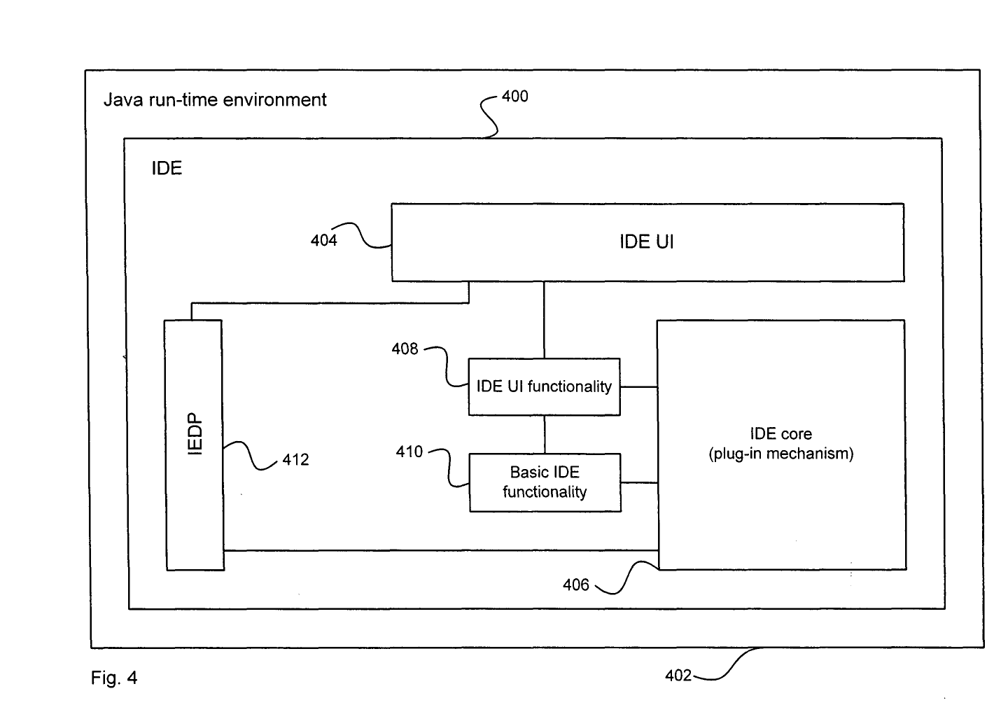

FIG. 4 schematically illustrates components of an embodiment of an IDE 400. For example, the IDE 400 may be a variant of the well-known Eclipse IDE. The IDE 400 is embedded within a run-time environment 402 on a computer (not shown), which may be a general purpose computer. As illustrated in FIG. 4, the run-time environment 402 may be Java-based.

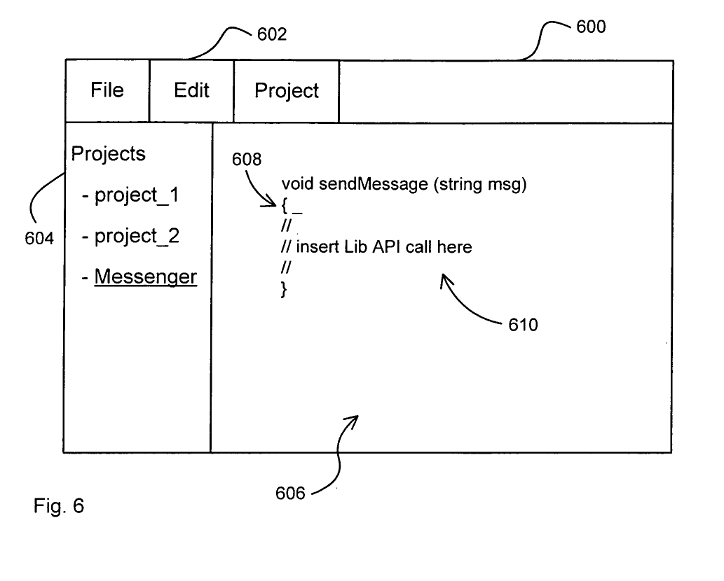

The IDE 400 provides a user interface 404 to the developer using the IDE. The user interface may be a graphical user interface (GUI) such as that described further below with reference to FIG. 6. The IDE 400 further comprises a core component 406 which comprises a plug-in mechanism for incorporating plug-ins into the IDE 400. The core component 406 may comprise a managing component (not shown), which manages integrated add-ons and, e.g., automatically starts available modules in the sequence required for proper functioning.

The IDE 400 further comprises a component 408 including basic functionality related to the user interface 404 and a component 410 including some basic functionality of the IDE 400, for example one or more editors or compilers. The components 408 and 410 may comprise built-in and/or add-on components. The IDE 400 further comprises an integration component or IEDP 412, which may operate as illustrated in FIG. 1, FIG. 2 (stage II), or FIG. 3. With the IEDP 412, the IDE 400 is capable of automatically incorporating external software libraries or extensions including feature description data such as the IDE extension description of FIG. 2. The IEDP 412 may be accessed via the IDE UI 404.

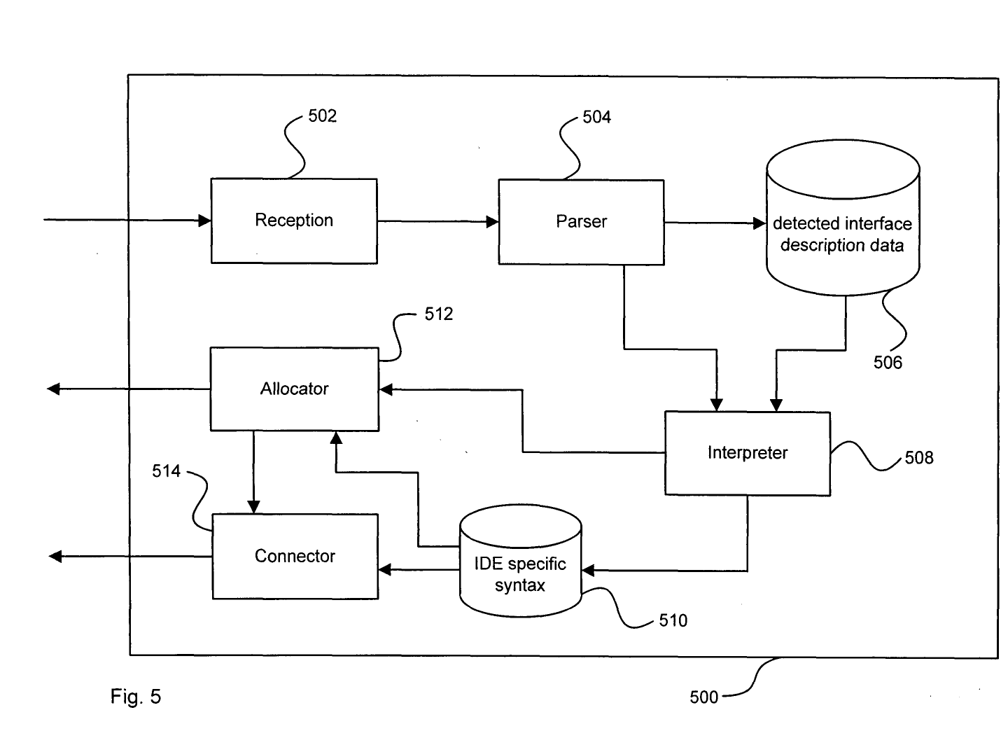

FIG. 5 is a functional block diagram schematically illustrating components of an embodiment of a tool 500 for a software development environment such as an IDE for automatically generating software. While the tool 500 may be assumed to be an implementation of the IEDP 412 of FIG. 4, it may form in general part of any integration component for integrating operations in a software development environment. As one of its essential functions is to interpret feature description data related to a library, one may also call the tool 500 an interpreter. The tool 500 may be a built-in component of an environment as illustrated in FIG. 4, or may be a stand-alone tool.

The tool 500 comprises a reception component 502 which is adapted to accept input data. The component 502 analyses the input data and accepts these in case it determines that the input data is a software artifact in an expected format. In case the software artifact is accepted, the component 502 provides it to a parser 504, which is adapted to parse the accepted input data in order to detect any included feature description data. In general, the parser may scan the entire input data, for example the entire code of a program library, for the occurrence of feature description data, which may for example be embedded within the code. Any detected feature description data may be extracted from the input data and may be buffered in a storage component 506. Having parsed the input data, the parser 504 provides a trigger signal to an interpreter component 508.

The interpreter 508, upon reception of the trigger signal from the parser 504, receives the feature description data from the buffer 506. The interpreter 508 interprets the feature description data in buffer 506 as a machine-readable description of a feature to be provided by the software development environment, the tool 500 is associated with. The interpretation may comprise, amongst others, mapping the feature description data to a format specific for a particular software development environment. The format may be an executable format, plug-in format or API format specific for the implementation of the particular software development environment, i.e. the format in which the development environment and its extensions are defined. To this end, a mapping table (not shown) may be provided, which contains associations of feature description data with an environment specific syntax.

The interpreter 508 buffers the interpreted data in the environment specific format in another buffer 510 and provides a trigger signal to an allocator 512. This component accesses the specific data in the buffer 510 and allocates one or more user-operable control elements of the software development environment. For example, one or more of menus, dialogs, buttons, etc. may be instantiated or prepared for instantiation.

The allocator 512 triggers a connector component 514 which is adapted to provide access, according to the feature description data, to a functionality implemented by the program library with which the detected feature description data are associated. The access will be provided via the control element. Therefore the connector 514 extracts from the data in buffer 510 information related to which operation is to be performed upon an activation of the control element allocated by the allocator 512; e.g., a function call related to a function implemented in the program library is to be included in a code to be developed, or an editor or compiler, which is provided or invoked by the library, is to be started, or some analysis is to be performed on an application software. The connector defines the connection between the control element and the action.

While the operation of the tool 500 has been described in a sequential manner for sake of clarity, it is to be noted that generally the various components of tool 500 may operate in parallel to integrate one or more libraries. For example, the parsing, interpreting and allocating components may operate in parallel on the feature description data of a library and may interact with each other to control their respective operations. For example, the interpreter 508 may, upon operating on a piece of data in storage 506, provide a trigger signal (not shown) to the parser 504 to continue or stop the parsing of the input data.

FIG. 6 is a schematic illustration of an embodiment of a graphical user interface (GUI) 600 as it may be presented to a user. For example, the GUI 600 may be generated by the user interface component 404 of IDE 400 from FIG. 4.

The GUI 600 shows a menu bar 602, a side bar 604 and a working area 606. The menu bar 602 offers various menus, such as “File”, “Edit”, “Project”, to the developer. The side bar 604 indicates various projects of the developer. In the example of FIG. 6, a “Messenger” project for a software system implementing a mobile phone application for sending messages such as SMS or MMS has been opened and is presented in the working area 606. While a function sendMessage has been prepared already, there is no body for the function included yet. At the position of the cursor 608, the developer may either enter some lines of code or, as suggested by a comment 610, insert a function call to a function provided by a library including such a function. The appearance of the GUI 600 after integration of the Mobile_Messaging IDE extension of FIG. 2 will be shown further below.

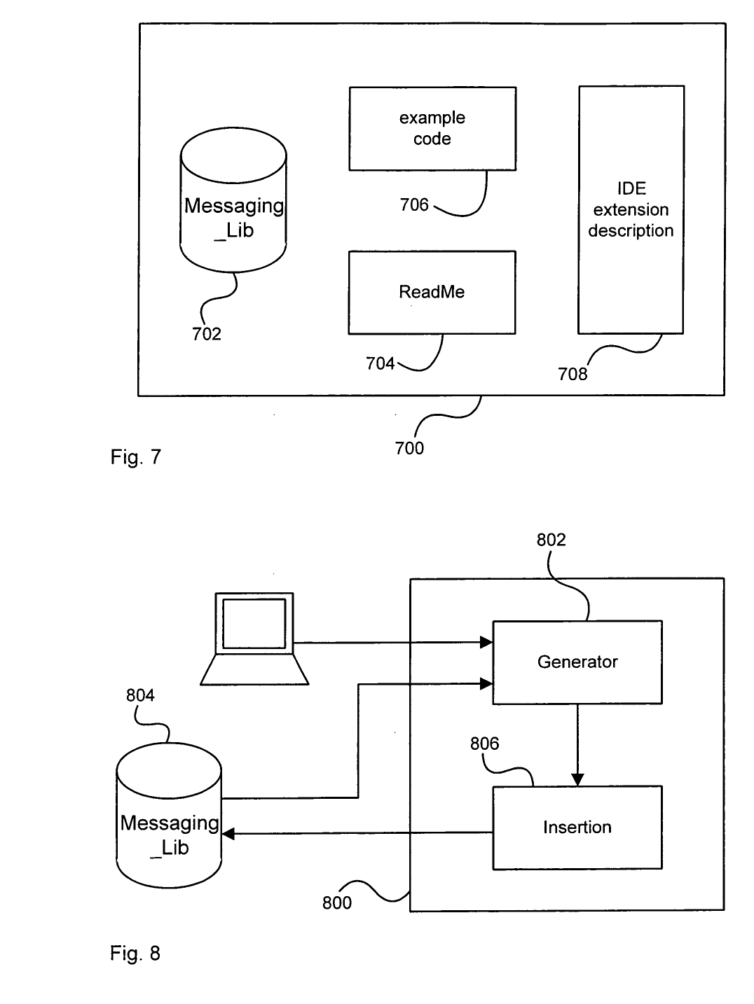

FIG. 7 schematically illustrates an embodiment of an IDE extension 700 including a program library for incorporation into one or more software development environments. It is exemplarily assumed that the IDE extension 700 is the Mobile_Messaging extension which has been generated in stage I of the process of FIG. 2.

The Mobile_Messaging extension 700 comprises the program library Messaging_Lib 702. As further components, the extension 700 comprises an information file 704 intended for perception by a human user, e.g. a developer, who is going to decide whether to include Mobile_Messaging into his or her project. The extension 700 further comprises example code 706 and feature description data 708, which may be the IDE extension description generated in step 206 in FIG. 2. While it is illustrated in FIG. 7 that the feature description data 708 is a component distinct from the program library 702, the feature description data 708 may well be integrated within the library 702, for example in the form of comments or annotations in the code constituting the library 702.

FIG. 8 is a functional block diagram illustrating components of an embodiment of a tool 800 for providing a program library for incorporation into one or more software development environments. The tool 800 may be adapted, for example, to perform the step 206 of FIG. 2. The tool 800 may be a stand-alone tool or may be integrated within a program library provisioning tool such as that used in stage I of FIG. 2. For instance, the tool 800 may be embedded within a software development environment.

The tool 800 comprises a generator 802, which is a component adapted to provide feature description data representing a machine-readable description of a feature to be provided by the software development environment such as IDE 400 in FIG. 4. The feature is related to a functionality implemented by the program library, which may be library 702 in FIG. 7. For example, the generator 802 may be used to compose the IDE extension description 708 of the Mobile_Messaging extension 700 of FIG. 7. To this end, the generator 802 may access a program library 804, which is illustrated in FIG. 8 as the Messaging_Lib library (see also library 702 in FIG. 7). For example, the generator 802 may scan the program library 804 in order to determine, for example, a hierarchical structure of the enclosed functions, classes, etc., user interface related functions, and/or other aspects related to a use of the library. Additionally or alternatively, the developer of the library 804 may also manually provide the feature description data. For example, the generator 802 may be adapted for generating feature description data from manual input, provide predefined fragments of feature description data, etc.

The generator 802 provides the generated feature description data to an insertion component 806. This component is adapted to include the feature description data within the code of the library 804. For example, the insertion component 806 may embed comments representing the feature description data in a header part or a body of functions, subroutines, or similar program structures. In the alternative, the insertion component 806 may also provide the feature description data in the form of an extra file, e.g. an HTML file, to the program library 804.

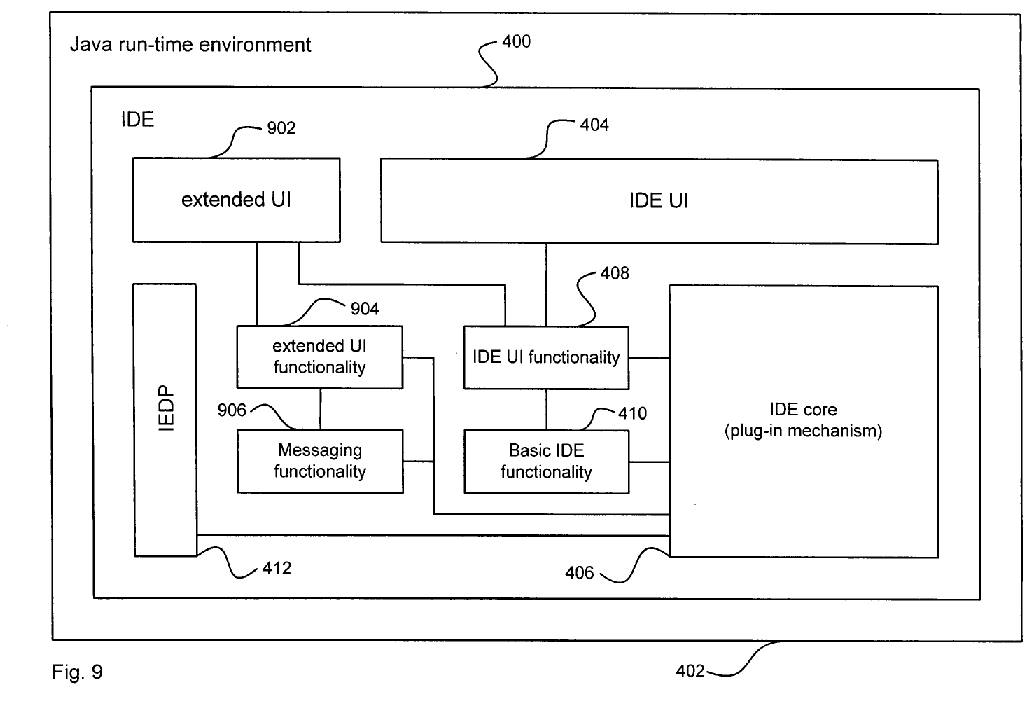

FIG. 9 schematically illustrates the functional structure of IDE 400 of FIG. 4 after incorporation of the Mobile_Messaging extension 700 of FIG. 7. The components 404-412 in FIG. 9 correspond to the respective components in FIG. 4. The interpreter or IEDP 412 has integrated the Mobile_Messaging extension into the IDE 400. As a result, the IDE user interface 404 has been extended by an additional user interface (UI) 902. This interface, which may comprise new menu structures, buttons, input forms, etc. is supported by a component 904 comprising extended UI functionality, which in turn may be connected with further Messaging_Lib functionality in component 906. The component 906 contains messaging functions specific for the domain of mobile applications The extended UI functionality of component 904 or 906 may make use of IDE functionality for providing storage places, basic data structures or input/output functionality, etc.

Both components 904 and 906 have been extracted from the Messaging_Lib library 702 illustrated in FIG. 7. The IDE core component 406 manages the built-in components 408 and 410 and also the add-on components 904 and 906. This is possible, because the IDE extension description 708 (cf. FIG. 7) contains a description of dependencies and interrelations of the functionality included in the components 904 and 906 as well as a required support by the IDE 400, for example via basic functionality included in components 408 and 410. The extended UI 902 is also supported by basic functionality of component 408 of IDE 400. As a concrete example, the component 408 may comprise an SDK including basic prescriptions for menus, buttons and other elements of a user interface. These may be used for the IDE user interface 404 and may be re-used for the extended user interface 902. The functionality connected to the interaction of a user with the extended UI 902 may be provided by the components 904 and 906.

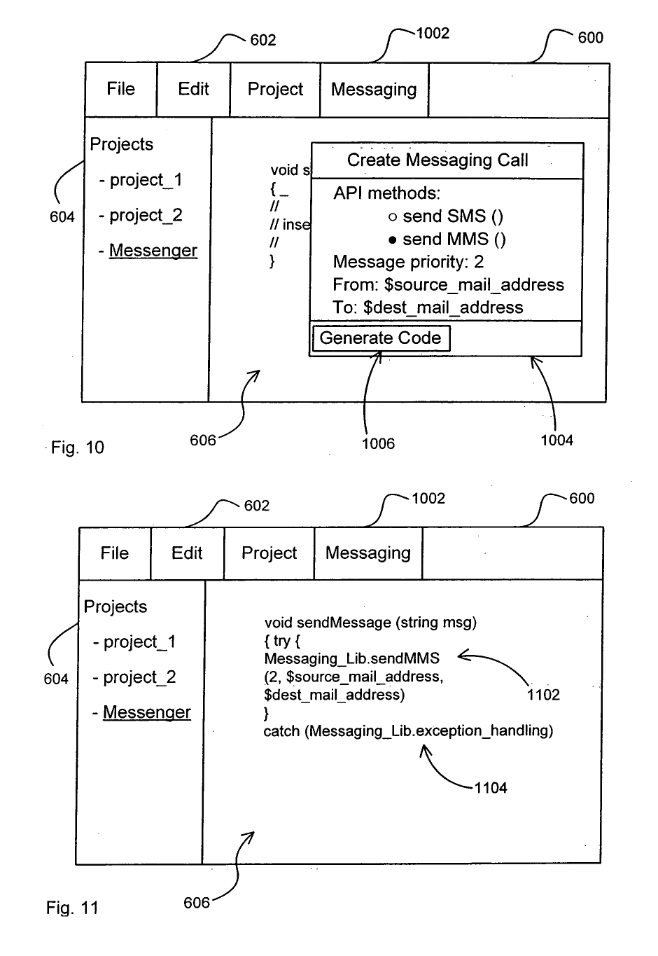

FIG. 10 schematically illustrates a possible appearance of the IDE GUI 600 of FIG. 6 after integration of the Mobile_Messaging extension 700. The GUI 600 in FIG. 10 may be generated by the UI component 404 and the extended UI component 902 of FIG. 9. The IDE GUI 600 now comprises in its tool bar 602 a new menu point “Messaging” 1002, which enables a user to access operations implemented by component 906 of FIG. 9.

In the working area 606, a pop-up window 1004 is shown which may be reached via menu 1002. The window 1004 is generated based upon functionality implemented by the component 904 for providing the extended user interface. The pop-up window 1004 displays an input form for defining a function, which may be included as a template function in the component 906. The layout (“look & feel”) of dialog 1004 may be generated using functionality provided by component 408 of IDE 400.

In the dialog 1004, the user may enter, for example, the type of the message to be sent. In the example illustration of FIG. 10, the user has chosen to define a function sendMMS ( ). Pre-defined default values are offered to the developer for further parameters required for calling the corresponding function. For example, a message priority may be set by default to the value 2. Further, variables for parameters such as From: and To: addresses may be defined or the default values may be used. An extended user interface may thus support the developer by hiding a complex function call and offering instead input options such as pop-up windows, default values, etc.

The window 1004 provides a “Generate Code” button 1006, which, when pressed, causes the dialog 1004 to disappear and a syntactic structure representing a function call to be inserted at the position of the cursor in the working area 606 (see cursor position 608 in FIG. 6). The result of pressing the button 1006 in FIG. 10 is schematically illustrated in FIG. 11. In the working area 606, the comment 610 of FIG. 6 has been automatically replaced by a call to a function Messaging_Lib.sendMMS ( ) (reference numeral 1102). The further parameters of window 1004 in FIG. 10 have been automatically included as parameters in the function call. Further, an error handling has automatically been included (reference numeral 1104). The code lines 1102 and 1104 may have been generated by the interaction of components 904, 906 and 406-410 of the IDE 400 as illustrated in FIG. 9.

It is noted that feature description data such as the IDE extension description discussed in the example embodiments herein may not comprise executable code for implementing a user interface such as the extended user interface 902 schematically illustrated in FIG. 9 and providing the menu 1002 of FIG. 10. The reason is that an executable code for implementing an IDE extension would be dependent on a particular programming language or programming platform, and thus requires a particular run-time environment which may not be available in any software development environment. This would limit the usability of the program library associated with the feature description data in terms of its integration in as many software development environments as possible. For maximum usability, feature description data should be provided in a form which is as independent of any particular software development environment(s) as possible or desirable. For example, feature description data may be provided using XML and/or Java syntax, as such syntax can be understood by nearly all IDEs.

As an example for feature description data, consider the following code in a library Example_Lib:

@TemplateClass
class ServletBaseTemplate {
@TemplateMember
void doEvent1(Event event);
@TemplateMember
void doEvent2(Event event);
// The next function is not a template
void processEvent(Event event);
}

Feature description data related to this code may be as follows:

<onButton “Generate from Template”
action=”GenerateFromTemplateAction”/>
<action name=”GenerateFromTemplateAction”>

<select_class label=”Template classes”
from=”defined_in(Example_Lib) &&

annotated(@TemplateClass)” variable=”SelectedClass”>

<enter_name type=”classname” label=”Name of the class to be

generated” variable=”NewClassName”>

<create_class name=”$(NewClassName)”

fromClass=”$(SelectedClass)”
methods=”annotated(@TemplateMember)”>
</action>

The GUI-related part of the feature description data specifies a simple dialog comprising a button that, when pressed, results in a display of a list of classes defined in the library and annotated as @TemplateClass. This annotation is defined within the library as exemplarily illustrated above. The user (application developer) may then select a particular class from the displayed list and may specify a name for the selected class. In response to this selection process, the new class is generated and added to a project. The new class contains all methods annotated as @TemplateMember in the template class. Assuming that the IDE user selects the class ServletBaseTemplate and specifies “MyServlet” as the name for this class, a code fragment would be generated as follows:

// Generated from @TemplateClass
class MyServlet {
// Generated from @TemplateMember
void doEvent1(Event event) {
}
// Generated from @TemplateMember
void doEvent2(Event event){
}
}

In this example the extended user interface provided to the developer is mostly derived from the API and the class provided by the library. The rudimentary GUI description part requires that basic functionality of the IDE is used to specifically provide the required button embedded in the IDE GUI as well as the presentation of the selection list and the input form for enabling the user to enter the new class name. Further, it is up to the IDE to arrange for the generated code to be displayed within the GUI.

The techniques proposed herein allow the integration of software artifacts such as program libraries, SDKs, extensions, etc. into software development environments for automatically generating software in a way, which is independent of a particular development environment. In other words, an IDE support (feature description data) of the libraries need not to be specifically adapted to a particular development environment. This increases the usability of libraries and saves development costs, as a library may be included in multiple development environments without the necessity to develop multiple environment specific plug-ins. As developers may include a required library automatically into their preferred development environment, the development process becomes more efficient.

Feature description data may be added to a library or extension. These data may represent a high level description or “meta model” for user interface extensions and operations associated therewith for a specific library. The meta model expresses aspects of an interaction with the user, but it does not necessarily specify in detail how these aspects may be realized. For example, the meta model may describe the inputs required from the user, but may not specify the details of the user interface required for entering those inputs. Rather, required actions, interactions and user interface elements are specified on an abstract level only. This approach allows at the same time the efficient generation of (unspecific or specific) IDE extensions in a semi-automated or even fully automated way, and/or provides for the platform independence of libraries, SDKs, build scripts and similar artifacts.

Taking the last point further, in principle all the features of an IDE (except possibly the core plug-in/extension integration mechanisms) may be provided by IDE independent extensions. Thus IDEs are essentially standardised containers for a set of features which the developer may freely combine according to its requirements. Such a situation may be seen as being comparable to a situation in which several Web browsers offer essentially the same features, but differ only in their “Look & Feel”.

Embedding the feature description data into a code implementing a related functionality, e.g. in the form of comments or annotations, guarantees that the data are preserved even in a compiled code. This is a relevant advantage as many vendors provide their libraries in a compiled, binary form, i.e. without source code. Further, version mismatch problems are avoided.

While the current invention has been described in relation to its preferred embodiments, it is to be understood that this disclosure is for illustrative purposes only. Accordingly, it is intended that the invention be limited only by the scope of the claims appended hereto.

1. A method for automatically generating software in a software development environment, the method comprising the following steps:
receiving (108) feature description data related to a program library;
interpreting (110, 226, 308-312) the feature description data as a machine-readable description of a feature to be provided by the software development environment;
allocating (112, 228, 314, 316), based on the interpreted feature description data, one or more user-operable control elements (1002-1006) in the software development environment (400); and
providing access (114, 228, 316), via the control element, to one or more operations related to the feature indicated by the feature description data.

2. The method according to claim 1,
wherein at east one of the one or more operations are based upon a functionality implemented by the program library.

3. The method according to claim 1 or 2,
wherein the feature is related to an automatic generation, in response to an activation of the control element, of at least one software fragment (1102, 1104) for an application to be developed by the software development environment.

4. The method according to claim 3,
wherein the software fragment is related to a function implemented by the program library.

5. The method according to any one of the preceding claims,
wherein the feature is related to a tool to be provided by the software development environment for supporting a software development process.

6. The method according to any one of the preceding claims,
wherein the feature description data are provided for being interpreted in different software development environments.

7. The method according to any one of the preceding claims,
wherein the feature description data are provided in at least one of a general programming language and a specific feature description language.

8. The method according to any one of the preceding claims,
wherein different portions of the feature description data are specified in different machine-readable languages.

9. The method according to any one of the preceding claims, wherein the step of receiving the feature description data comprises the steps of
accepting (104, 222, 304) input data (700); and
parsing (106, 224, 306) the accepted input data to detect the feature description data (708).

10. The method according to claim 9,
wherein the input data comprise the program library (702).

11. The method according to claim 10,
wherein the feature description data are included within the code of the program library.

12. The method according to claim 11,
wherein the feature description data are included within at least one of a source code or a binary code of the library.

13. The method according to claim 11 or 12,
wherein the feature description data are embedded within the code in the form of at least one of comments and annotations.

14. The method according to any one of the preceding claims,
wherein the feature description data comprise multiple portions related to at least one of user inputs, user interface functionality, wizard functionality, requirements on the software development environment and requirements on a run-time environment.

15. The method according to any one of the preceding claims,
wherein the feature description data comprise a fragment of executable code for being executed by one of the software development environment and an application to be developed based on the software development environment.

16. The method according to any one of the preceding claims,
wherein the feature is a domain-specific feature.

17. The method according to any one of claims 6 to 16,
wherein the feature description language comprises at least one of HTML, XML, XUL and WSDL.

18. A computer program product comprising program code portions for performing the steps of any one of the preceding claims when the computer program product is executed on one or more computing devices.

19. The computer program product of claim 18, stored on a computer readable recording medium.

20. A tool for a software development environment for automatically generating software, the tool (412, 500) comprising:
a first component (508) adapted to receive feature description data related to a program library;
a second component (508) adapted to interpret the feature description data as a machine-readable description of a feature to be provided by the software development environment;
a third component (512) adapted to allocate, based on the interpreted feature description data, one or more user-operable control elements (1002-1006) in the software development environment; and
a fourth component (514) adapted to provide access, via the control element, to one or more operations related to the feature indicated by the feature description data.

21. A tool for providing a program library for incorporation into one or more software development environments, the tool (800) comprising a component (802) adapted to provide feature description data representing a machine-readable description of a feature to be provided by the software development environment, the feature being related to a functionality implemented by the program library (804).

22. The tool according to claim 21,
comprising a further component (806) adapted to include the feature description data within the code of the program library.

23. A program library for incorporation into one or more software development environments, the library (702) including feature description data (708) representing a machine-readable description of a feature to be provided by the software development environment, the feature being related to a functionality implemented by the program library.
